(19) United States
(12) Patent Application Publication
(10) Pub. No.: US 2007/0079526 A1
(43) Pub. Date: Apr. 12, 2007

(54) Domestic dryer and method for detecting a rotary movement of a drum

(75) Inventor: Henrik Volkers, Braunschweig (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/546,668

(22) Filed: Oct. 11, 2006

(30) Foreign Application Priority Data
Oct. 12, 2005 (DE) 10 2005 048 890.0

(51) Int. Cl. F26B 21/00; F26B 19/00

(52) U.S. Cl. 34/524; 34/572

(57) ABSTRACT

The invention relates to a domestic dryer and a method for detecting a rotary movement of a drum (16) driven by a motor (24), which takes place by means of a device (44) which comprises a capacitive sensor (45). This capacitive sensor (45) has a first conducting armature (46) arranged in a part (50) that rotates with the drum (16) during its rotary movement and a second conducting armature (48) which is arranged fixedly opposite the first conducting armature (46). On the basis of the capacitance variation of the capacitive sensor (45) occurring during the rotary movement of the drum (16) it can therefore be determined whether the drum (16) has stopped due to a fault.

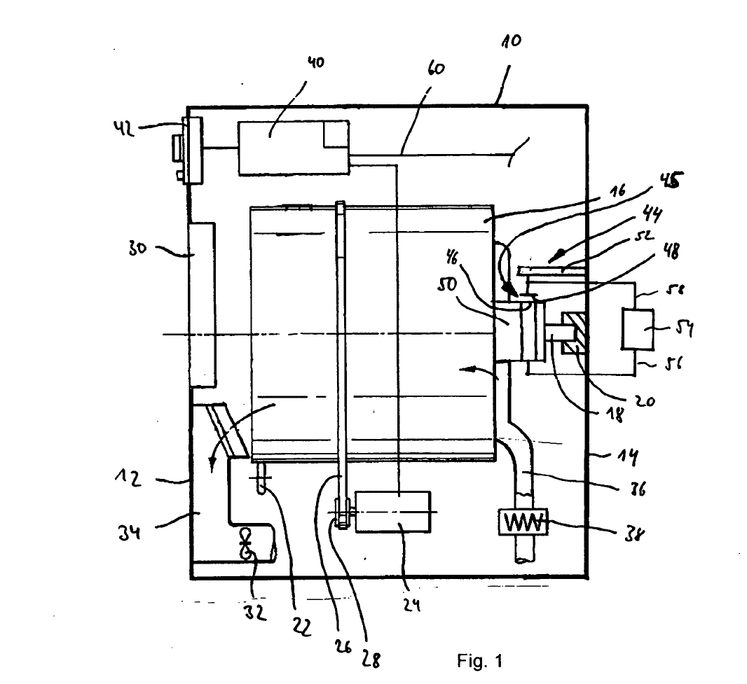

The invention relates to a domestic dryer and a method for detecting a rotary movement of a drum of a domestic dryer, which drum is rotatable by means of a motor.

In such domestic dryers, disclosed quite generally, for example, in DE 102 59 344 A1 or DE 103 60 867 A1, a rotary drum for receiving items to be dried is driven by means of a motor. The driving torque of the motor is here transmitted, for example, by a belt, to which a reduction gear is connected in series, if necessary, for better control of the drum speeds. The drive can be interrupted and the drum may stop abruptly during the process of drying the items to be dried as a result of defective components or other faults, such as damage to the motor, cracking of the drive belt connecting the motor to the drum, slipping of the drive belt due to too small a belt tension or locking of the drum, for example. In particular, if heating takes place that is activated during the drying process for heating an air flow flowing through the items to be dried, this may result in overheating of components inside the domestic dryer.

For this reason devices are provided, in domestic dryers currently in use, with which a rotary movement or stopping of the drum can be detected. Centrifugal switches, for example, are used for this purpose, which switches record a rotary movement of the motor drive shaft. Moreover, a method is already known for detecting the cracking of a drive belt by means of a so-called belt crack switch. Finally, tachometric sensors are also known in the field of domestic dryer manufacture, where a magnet is arranged on a part rotatably moved by the motor, for example the drum, the drum bearing wheel or a toothed wheel, and whose rotary movement is recorded, for example, by means of a Hall generator or other recording means.

The object of the invention is to improve a domestic dryer and a method for detecting a rotary movement of a drum of the type already mentioned so that an overwhelming number of faults resulting in stoppage of the drum can be determined in a structurally simple manner.

This object is achieved according to the invention by a domestic dryer and a method for detecting a rotary movement of a drum with the features recited in the claims.

Advantageous embodiments, with suitable and non-trivial further developments of the invention, are described in the remaining claims.

In the domestic dryer according to the invention the device for detecting a rotary movement or stopping of the drum comprises a capacitive sensor whose first conducting armature is arranged on a part that rotates with the drum and whose second conducting armature is rigidly arranged opposite the first armature. In other words both conducting armatures form an electrical capacitor whose first conducting armature is rotated according to the rotary movement of the drum and whose second conducting armature remains rigidly opposed to it. Here both conducting armatures are arranged rigidly on the part rotating with the drum or opposed to it in such a manner that a gap forming the insulating dielectric is formed between the two armatures.

In the method provided according to the invention for detecting a rotary movement of the drum, the capacitance of the capacitive sensor formed by the first and second conducting armatures is determined in this case. Here allowance is made for the fact that the drum naturally has a certain out-of-balance because of design-conditioned irregularities such as folds, welded seams and embossing, as well as production tolerances, and that consequently the distance between and the overlapping of the two armatures vary in the course of the rotary movement of the drum. The variation in capacitance caused thereby in the course of the rotary movement of the drum can in this case be recorded extremely simply.

In contrast to centrifugal switches of prior art on the drive shaft—which cannot record a crack on the drive belt, for example—and belt crack switches—which do not detect a sipping drive belt, for example—the use according to the invention of a capacitive sensor arranged directly on a part rotating with the drum during its rotary movement enables almost all faults that may result in the drum stopping during a drying process to be recorded. Here the measurement is carried out in a particularly simple and reliable manner.

For example, it has proved particularly advantageous to form a first conducting armature n the outer circumference of a drum neck or of the drum itself. Consequently the capacitive sensor can be constructed generally very simply, enabling the rotary movement or stoppage of the drum—unlike a centrifugal switch on the drive shaft, for example—to be detected directly on the drum itself. A particularly simple design of the first conducting armature is obtained in that the latter is formed directly by the outer circumferential surface of the drum or drum neck. According to the invention at least the drum neck consists in most cases of a conducting metal and is normally well earthed so that the outer circumferential surface of the drum neck is particularly suitable for the formation of a capacitor.

It has also proved advantageous to design the first conducting armature, rotating with the drum, as a fully rotating annular armature on the outer circumference of the drum or drum neck. This enables the capacitance variation of the capacitive sensor to be determined throughout the rotation of the drum. Similarly it would also be naturally conceivable to arrange the first conducting armature only in certain regions on the outer circumference of the drum. It would therefore be conceivable, for example, to provide the first conducting armature on only one quarter or half of the outer circumference. In this case it would also be conceivable, of course, for the conducting armature to be formed from a part separate from the drum or the drum neck, which part is then fixed, for example, by a glued joint to the outer circumference of the drum or drum neck.

In implementing the method according to the invention it has also proved advantageous to determine the capacitance variations of the capacitive sensor over a predetermined period of time. This ensures a particularly reliable detection of a drum stoppage. If, during this predetermined period of time, no capacitance variation is determined, a signal is generated, for example, for switching off a heating system and/or the motor.

Further advantages, features and details of the invention may be deduced from the following description of a preferred exemplary embodiment and with reference to the drawing, which shows:

a diagrammatic sectional view through a domestic dryer with a drum rotatable by means of a motor, and with a device for detecting the rotary movement of the drum.

The figure shows essentially a housing 10 of a domestic dryer with an upper and lower side, and with a front end side 12 and a rear side 14. A drum 16, which is retained with a drum shaft 18 and a shaft bushing 20 fixedly connected to rear side 14—rotabably about drum axis T, is arranged inside the domestic dryer. Drum 16 is also retained by drum bearing wheel 22 at its end associated with front end side 12. A motor 24, which rotates a toothed wheel 28 engaging with a drive belt 26, is provided for rotatably driving drum 16. For this purpose drive belt 26 engages with a toothing provided on the outer circumference of drum 16 and is not shown.

The drum can be filled with wet items to be dried through a loading door 30 on end side 12 of housing 10. During the drying process drum 16 and the items to be dried inside it are acted upon by an air flow which is generated by a fan 32. Fan 32 is arranged in this exemplary embodiment inside an outlet duct 34 close to end side 12 of housing 10. A heating system 38 is arranged in an inlet duct 36 close to rear side 12 of housing 10, with which system the air flow flowing through drum 16 and the items to be dried can be heated. The drying process can be controlled by a program control 40 which is in contact with a control unit 42.

To enable an undesirable interruption in the rotary movement of drum 16 or stoppage—due for example to damage to the motor 24, cracking or slipping of drive belt 26 or locking of drum 16—to be determined, a device 44 is provided near rear side 14 of housing 10 for detecting the rotary movement of drum 16. This device 44 comprises a capacitive sensor 45, whose first conducting armature 46 is formed on the outer circumference of a drum neck 50 of drum 16. In this exemplary embodiment first conducting armature 46 associated with drum neck 50 is formed by the outer circumferential surface of drum neck 50 itself. For this purpose drum neck 50 consists of conductive metal, drum neck 50 normally being earthed. Moreover, in this exemplary embodiment first armature 46 is designed as a fully rotating annular armature on the outer circumference of drum neck 50. Similarly it would also be conceivable for first armature 46 to extend only over a partial length on the outer circumference of drum neck 50. It would also be conceivable to design first armature 46 as a separate part and to secure it to drum neck 50 by means of a glued joint, for example. A second conducting armature 46 is fixedly arranged on housing 10 and opposite first conducting armature 46 by means of a supporting part 52 on housing 10, opposing first conducting armature 46 rotating about drum neck 50. Second conducting armature 48 is formed in this exemplary embodiment by a small plate part which is arranged essentially surface parallel with the outer circumference of drum neck 50. Both conducting armatures 46, 48 are in this case arranged at such a distance from each other that a gap is formed which constitutes the insulating dielectric between the two armatures 46, 48 of capacitive sensor 45. In this exemplary embodiment the dielectric therefore consists of the ambient air present inside the domestic dryer.

An insulation, not shown in this exemplary embodiment, is provided between second conducting armature 48 and supporting part 52. As also included within the scope of the invention, it must be considered that instead of just one capacitive sensor 45 provided here, several sensors may of course also be arranged on the outer circumference of drum neck 50. In this exemplary embodiment this would be simple to implement in that a plurality of second conducting armatures 48 are arranged so that they are distributed opposite the outer circumference of drum neck 50.

If drum 16 is now rotated, out-of-balances occur on drum neck 50 because of production tolerances in the region of its outer circumference so that the distance between and overlapping of the two conducting armatures 46, 48 vary permanently throughout the rotary movement of drum 16. The capacitance variation can be detected by a suitable measuring device 54, which is connected by measuring cables 56, 58 to first and second armatures 46, 48. If the rotary movement of drum 16 is now interrupted or if the drum stops due to a fault, no further capacitance variation is therefore recorded by measuring device 54. For this purpose the capacitance is determined over a certain period of time by measuring device 54 and it is also determined whether there has been a capacitance variation or whether the capacitance of sensor 45 does not deviate from a predetermined value over a predetermined period of time. Thus if no capacitance variation of sensor 45 is established by measuring device 54, and a drum stoppage is therefore established, a fault signal may, for example, be transmitted to program control 40 via a signal cable 60. Motor 24, fan 32 and heating system 38 can then be switched off by program control 40 if necessary so that further damage inside the domestic dryer can be effectively avoided.

1-14. (canceled)

15. A domestic dryer comprising:
a housing;
a drum mounted for rotary movement with respect to the housing and receiving items to be dried;
a motor rotating the drum; and
a device for detecting rotary movement of the drum including a capacitive sensor having a first conducting armature arranged on a part that also rotates with the drum during its rotary movement, and a second conducting armature fixedly mounted with respect to the housing and arranged opposite the first conducting armature.

16. The domestic dryer according to claim 15, wherein the drum includes a drum neck having an outer circumference and the first conducting armature is formed on the outer circumference of the drum neck.

17. The domestic dryer according to claim 15, wherein the first conducting armature is formed on an outer circumference of the drum.

18. The domestic driver according to claim 16, wherein the first conducting armature is formed by the outer circumferential surface of the drum or of the drum neck.

19. The domestic dryer according to claim 16, wherein the first conducting armature is designed as a fully rotating annular armature formed on the outer circumference of at least one of the drum and the drum neck.

20. The domestic driver according to claim 16, wherein the second conducting armature is formed from a plate part which is arranged essentially surface parallel with the outer circumference of at least one of the drum and the drum neck.

21. The domestic dryer according to claim 15, further comprising an insulation disposed between the second conducting armature and a supporting part retaining the second conducting armature.

22. The domestic dryer according to one of claims 16, further comprising a plurality of second conducting armatures arranged distributed opposite the outer circumference of at least one of the drum and the drum neck.

23. The domestic dryer according to claim 15, wherein the device for detecting a rotary movement of the drum is connected by a program control to at least one of a heating system, a fan and the motor.

24. The domestic dryer according to claim 15, wherein the device for detecting a rotary movement of the drum comprises a measuring device with which a capacitance variation of the capacitive sensor can be determined.

25. A method for detecting a rotary movement of a drum of a domestic dryer, the dryer including a housing, a drum mounted for rotary movement with respect to the housing and receiving items to be dried, a motor, and a device for detecting rotary movement of the drum including a capacitive sensor having a first conducting armature arranged on a part that also rotates with the drum during its rotary movement, and a second conducting armature fixedly mounted with respect to the housing and arranged opposite the first conducting armature, the method comprising the acts of:
rotating the drum with the motor;
determining the capacitance variation of the capacitive sensor,
determining the rotary movement of the drum in response to the capacitance variation.

26. The method according to claim 25, wherein the capacitance variation of the capacitive sensor is determined over a pre-determined period of time.

27. The method according to claim 26, wherein if there is no capacitance variation of the capacitive sensor during the pre-determined period of time, generating a signal indicating the detection of a drum stoppage.

28. The method according to claim 27, wherein if a drum stoppage is detected, switching off at least one of a heating system, a fan, and the motor.
